(19) United States
(12) Patent Application Publication
(10) Pub. No.: US 2025/0079518 A1
(43) Pub. Date: Mar. 6, 2025

(54) ELECTROLYTE ADDITIVES FOR RECHARGEABLE LITHIUM BATTERY, ELECTROLYTE INCLUDING THE SAME, AND RECHARGEABLE LITHIUM BATTERY INCLUDING THE SAME

(71) Applicant: SAMSUNG SDI CO., LTD., Yongin-si (KR)

(72) Inventors: Inah KANG, Yongin-si (KR); Tae Jin LEE, Yongin-si (KR); Si-Young CHA, Yongin-si (KR); Hanmam JEONG, Yongin-si (KR)

(21) Appl. No.: 18/776,127

(22) Filed: Jul. 17, 2024

(30) Foreign Application Priority Data
Aug. 29, 2023 (KR) 10-2023-0113819

(51) Int. Cl. H01M 10/0567; H01M 10/0525; H01M 10/0568; H01M 10/0569

(52) U.S. Cl. CPC H01M 10/0567; H01M 10/0525; H01M 10/0568; H01M 10/0569; H01M 2300/004; H01M 2300/0051

(57) ABSTRACT

An electrolyte additive for a rechargeable lithium battery includes a polymer obtained by polymerizing first compound represented by Chemical Formula 1, Chemical Formula 2, or Chemical Formula 3 as a monomer; and second compound represented by Chemical Formula 4.

### CROSS-REFERENCE TO RELATED APPLICATION

The present application claims priority to and the benefit of Korean Patent Application No. 10-2023-0113819, filed on Aug. 29, 2023, in the Korean Intellectual Property Office, the entire content of which is incorporated herein by reference.

### BACKGROUND

### 1. Field of the Invention

Embodiments of the present disclosure described herein are related to electrolyte additives for a rechargeable lithium battery, electrolytes, and rechargeable lithium batteries including the same.

### 2. Description of the Related Art

A rechargeable lithium battery may be recharged and has three or more times as high in energy density per unit weight as compared to that of a comparable lead storage battery, nickel-cadmium battery, nickel hydrogen battery, nickel zinc battery and/or the like. It may be also charged at a relatively high rate and thus, is commercially manufactured for a laptop, a cell phone, an electric tool, a vehicle (e.g., an electric car, an electric bike, etc.), and/or the like, and improvement of additional energy density have been researched and/or pursued.

A rechargeable lithium battery may be formed by injecting an electrolyte into an electrode assembly including a positive electrode including a positive electrode active material capable of intercalating and deintercalating lithium and a negative electrode including a negative electrode active material capable of intercalating and deintercalating lithium.

For example, an electrolyte includes an organic solvent in which a lithium salt is dissolved and may determine stability and performance of a rechargeable lithium battery.

LiPF₆ may be utilized as a lithium salt of an electrolyte, but has a problem of reacting with an electrolytic solvent to promote depletion of a solvent and generate a large amount of gas. For example, when LiPF₆ decomposes, LiF and PF₅ are generated, which causes electrolyte depletion in the battery, resulting in deterioration of performance in relatively high-temperature conditions and vulnerability to safety.

Accordingly, there is a demand or desire for an electrolyte with improved safety without deteriorating performance even under relatively high-temperature conditions, and these problems are being addressed or study by introducing one or more suitable additives into the electrolyte.

### SUMMARY

Aspects according to one or more embodiments are directed toward an electrolyte additive for a rechargeable lithium battery with improved thermal stability by suppressing or reducing explosion and ignition if (e.g., when) the battery is exposed to relatively high temperatures and preventing or reducing temperature rise of the battery.

Aspects according to one or more embodiments are directed toward an electrolyte additive for the rechargeable lithium battery that can improve the thermal stability of a rechargeable lithium battery by suppressing or reducing explosion and ignition if (e.g., when) the battery is exposed to relatively high temperatures and preventing or reducing temperature rise of the battery.

Additional aspects will be set forth in part in the description which follows and, in part, will be apparent from the description, or may be learned by practice of the presented embodiments of the present disclosure.

According to one or more embodiments, an electrolyte additive for a rechargeable lithium battery includes a polymer obtained by polymerizing a first compound represented by Chemical Formula 1, Chemical Formula 2, or Chemical Formula 3 as a monomer; and a second compound represented by Chemical Formula 4.

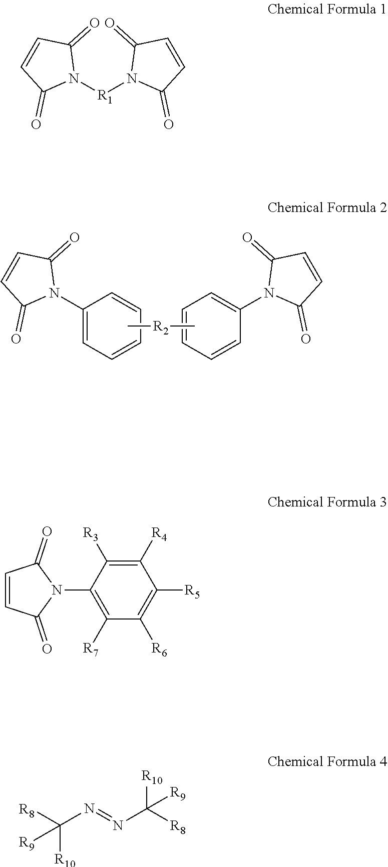

In Chemical Formula 1, R₁ is a substituted or unsubstituted C1 to C4 alkylene group, —C(O)CH₂—, —ROR′OR—, —CH₂OCH₂—, —C(O)—, —O—, —O—O—, —S—, —S—S—, —S(O)—, —CH₂S(O)CH₂—, —(O)S(O)—, —CH₂(C₆H₄)CH₂—, —CH₂(C₆H₄)O—, a substituted or unsubstituted phenylene group, or a substituted or unsubstituted biphenylene group, wherein R is a C1 to C4 alkylene group and R′ is a C1 to C4 alkylene group,
in Chemical Formula 2, R₂ is a substituted or unsubstituted C1 to C4 alkylene group, —C(O)—, —C(CH₃)₂—, —O—, —O—O—, —S—, —S—S—, —(O)S(O)—, or —S(O)—,
in Chemical Formula 3, R₃ to R₇ may each independently be hydrogen, a halogen, a substituted or unsubstituted C1 to C6 alkyl group, a substituted or unsubstituted C1 to C6 alkylene group, a substituted or unsubstituted C1 to C6 aryl group, a substituted or unsubstituted C1 to C6 ether group, or a substituted or unsubstituted C1 to C6 alkoxy group,
in Chemical Formula 4, R₃ to R₁₀ may each independently be hydrogen; a cyano group; a halogen; or a substituted or unsubstituted C1 to C10 hydrocarbon group including an alkyl group, a cycloalkyl group, an alkoxy group, a carboxyl group, an ester group, a carbonyl group, an amide group, a hydroxyl group, or a combination thereof (e.g., a suitable combination thereof), and
R₈ to R₁₀ may each exist independently, or at least two of them may be linked to form (or provide) a substituted or unsubstituted monocyclic or polycyclic aliphatic ring.

According to one or more embodiments, an electrolyte for rechargeable lithium battery according to one or more embodiments includes a non-aqueous organic solvent, a lithium salt, and the electrolyte additive for the rechargeable lithium battery.

According to one or more embodiments, the rechargeable lithium battery includes a positive electrode including a positive electrode active material; a negative electrode including a negative electrode active material; a separator between the positive electrode and the negative electrode; and the electrolyte for the rechargeable lithium battery.

### BRIEF DESCRIPTION OF THE DRAWINGS

FIG. 1 is a schematic view showing rechargeable lithium batteries according to one or more embodiments.

FIG. 2 is a graph showing temperature and voltage changes according to heat exposure at about 143° C. for rechargeable lithium battery cells according to Comparative Examples 1, 3, and 7 and Examples 6 and 10.

FIG. 3 is a graph showing the capacity retention rates (%) at relatively high temperature for the rechargeable lithium battery cells according to Example 1, Example 3, and Example 10.

FIG. 4 is a graph showing the capacity recovery rates (%) at relatively high temperature for the rechargeable lithium battery cells according to Example 1, Example 3, and Example 10.

FIG. 5 is a graph showing the direct current resistance increase rates (%) at relatively high temperature for the rechargeable lithium battery cells according to Example 1, Example 3, and Example 10.

FIG. 6 is a graph showing the open circuit voltage change rates (%) at relatively high temperature for the rechargeable lithium battery cells according to Example 1, Example 3, and Example 10.

FIG. 7 is a graph showing the capacity retention rates (%) at room temperature for the rechargeable lithium battery cells according to Example 1, Example 3, and Example 10.

### DETAILED DESCRIPTION

Hereinafter, specific embodiments will be described in more detail so that those of ordinary skill in the art can easily implement them. However, this disclosure may be embodied in many different forms and is not construed as limited to the example embodiments set forth herein.

The terminology utilized herein is utilized to describe embodiments only, and is not intended to limit the present disclosure. The singular expression includes the plural expression unless the context clearly dictates otherwise.

As utilized herein, “combination thereof” refers to a mixture, laminate, composite, copolymer, alloy, blend, reaction product, and/or the like of the constituents.

Herein, it should be understood that terms such as “comprises,” “includes,” or “have” are intended to designate the presence of an embodied feature, number, operation, element, and/or a combination thereof, but it does not preclude the possibility of the presence or addition of one or more other features, number, operation, element, and/or a combination thereof.

In the drawings, the thickness of layers, films, panels, regions, and/or the like, are exaggerated for clarity and like reference numerals designate like elements throughout, and duplicative descriptions thereof may not be provided in the specification. It will be understood that if (e.g., when) an element such as a layer, film, region, or substrate is referred to as being “on” another element, it can be directly on the other element or intervening elements may also be present. In contrast, if (e.g., when) an element is referred to as being “directly on” another element, there are no intervening elements present.

In one or more embodiments, “layer” herein includes not only a shape formed on the whole surface if (e.g., when) viewed from a plan view, but also a shape formed on a partial surface.

In one or more embodiments, the average particle diameter may be measured by a method suitable to those skilled in the art, for example, it may be measured by a particle size analyzer, or may be measured by a transmission electron micrograph or a scanning electron micrograph. In one or more embodiments, it is possible to obtain an average particle diameter value by measuring utilizing a dynamic light scattering method, performing data analysis, counting the number of particles for each particle size range, and calculating from this. The average particle diameter may be measured by a microscopic image or a particle size analyzer, and may refer to a diameter (D₅₀) of particles having a cumulative volume of 50 volume % in a particle size distribution.

Herein, “or” is not to be construed as an exclusive meaning, for example, “A or B” is construed to include A, B, A+B, and/or the like.

As utilized herein, expressions such as “at least one of”, “one of”, and “of (e.g., selected from among)”, when preceding a list of elements, modify the entire list of elements and do not modify the individual elements of the list. For example, “at least one of a, b or c”, “at least one selected from among a, b and c”, and/or the like, may indicate only a, only b, only c, both (e.g., simultaneously) a and b, both (e.g., simultaneously) a and c, both (e.g., simultaneously) b and c, all of a, b, and c, or variations thereof.

The term utilized herein is intended to describe only a specific embodiment and is not intended to limit the present disclosure. As utilized herein, the singular forms “a,” “an,” and “the” are intended to include the plural forms, including “at least one,” unless the content (e.g., amount) clearly indicates otherwise. “At least one” should not be construed as being limited to the singular. As utilized herein, the term “and/or” includes any and all combinations of one or more of the associated listed items. The terms “includes,” “including,” “comprises,” and/or “comprising,” when utilized in the detailed description, specify a presence of stated features, regions, integers, steps, operations, elements, and/or components, but do not preclude the presence or addition of one or more other features, regions, integers, steps, operations, elements, components, and/or groups thereof.

Spatially relative terms such as “beneath,” “below,” “lower,” “above,” and “upper” may be utilized herein to easily describe one element or feature's relationship to another element or feature. It will be understood that the spatially relative terms are intended to encompass different orientations of a device in utilize or operation in addition to the orientation illustrated in the drawings. For example, when a device in the drawings is turned over, elements described as “below” or “beneath” other elements or features would then be “above” or “over” the other elements or features. In some embodiments, the example term “below” may encompass both (e.g., simultaneously) orientations of above and below. The device may be otherwise oriented (rotated 90 degrees or at other orientations), and the spatially relative terms utilized herein may be interpreted accordingly.

The term “metal” as utilized herein includes all of metals and metalloids such as silicon and germanium in an elemental or ionic state.

The term “alloy” as utilized herein refers to a mixture of two or more metals.

The term “electrode active material” as utilized herein refers to an electrode material that may undergo lithiation and delithiation.

The term “composite cathode active material” as utilized herein refers to a cathode material that may undergo lithiation and delithiation.

The term “anode active material” as utilized herein refers to an anode material that may undergo lithiation and delithiation.

The terms “lithiate” and “lithiating” as utilized herein refer to a process of adding lithium to an electrode active material.

The terms “delithiate” and “delithiating” as utilized herein refer to a process of removing lithium from an electrode active material.

The terms “charge” and “charging” as utilized herein refer to a process of providing electrochemical energy to a battery.

The terms “discharge” and “discharging” as utilized herein refer to a process of removing electrochemical energy from a battery.

The terms “positive electrode” and “cathode” as utilized herein refer to an electrode at which electrochemical reduction and lithiation occur during a discharging process.

The terms “negative electrode” and “anode” as utilized herein refer to an electrode at which electrochemical oxidation and delithiation occur during a discharging process.

As utilized herein, the term “substantially” and similar terms are utilized as terms of approximation and not as terms of degree, and are intended to account for the inherent deviations in measured or calculated values that would be recognized by those of ordinary skill in the art. Also, the term “about” and similar terms, when utilized herein in connection with a numerical value or a numerical range, are inclusive of the stated value and a value within an acceptable range of deviation for the particular value as determined by one of ordinary skill in the art, considering the measurement in question and the error associated with measurement of the particular quantity (e.g., the limitations of the measurement system). For example, “about” may refer to within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

As utilized herein, if (e.g., when) specific definition is not otherwise provided, “substituted” refers to replacement of at least one hydrogen of a substituent or a compound by deuterium, a halogen, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, and/or a combination thereof.

For example, “substituted” refers to replacement of at least one hydrogen of a substituent or a compound by deuterium, a halogen, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, “substituted” refers to replacement of at least one hydrogen of a substituent or a compound by deuterium, a halogen, a C1 to C20 alkyl group, a C6 to C30 aryl group, a C1 to C10 fluoroalkyl group, or a cyano group. For example, “substituted” refers to replacement of at least one hydrogen of a substituent or a compound by deuterium, a halogen, a C1 to C5 alkyl group, a C6 to C18 aryl group, a C1 to C5 fluoroalkyl group, or a cyano group.

For example, “substituted” refers to replacement of at least one hydrogen of a substituent or a compound by deuterium, a cyano group, a halogen, a methyl group, an ethyl group, a propyl group, a butyl group, a phenyl group, a biphenyl group, a terphenyl group, a trifluoromethyl group, or a naphthyl group.

### Electrolyte Additive for a Rechargeable Lithium Battery

An electrolyte additive for a rechargeable lithium battery includes a polymer obtained by polymerizing a first compound represented by Chemical Formula 1, Chemical Formula 2, or Chemical Formula 3 as a monomer; and a second compound represented by Chemical Formula 4.

The electrolyte additive for a rechargeable lithium battery according to one or more embodiments includes both (e.g., simultaneously) a polymer including the first compound as a monomer and a second compound, thereby rapidly increasing a viscosity of the electrolyte at relatively high temperatures around about 100° C. As a result, an ionic conductivity of the electrolyte rapidly decreases to shut down a battery at relatively high temperatures, which has the advantage of suppressing or reducing explosion and ignition of the battery and preventing or reducing an increase in battery temperature.

### First Compound

The first compound is a maleimide-based compound including a maleimide group (

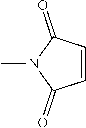

) at the terminal end, and is a monomer of radical polymerization including an unsaturated bond capable of radical polymerization at the terminal end.

The first compound may form (or provide) a polymer by initiating a radical polymerization reaction with the second compound, which will be described in more detail later.

As an example, the compound represented by Chemical Formula 1 or Chemical Formula 2 is a bismaleimide-based compound including maleimide groups at both (e.g., opposite) terminal ends.

The first compound is represented by Chemical Formula 1, Chemical Formula 2, or Chemical Formula 3.

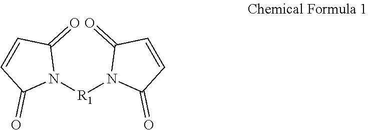

In Chemical Formula 1, R₁ is a substituted or unsubstituted C1 to C4 alkylene group, —C(O)CH₂—, —ROR′OR—, —CH₂OCH₂—, —C(O)—, —O—, —O—O—, —S—, —S—S—, —S(O)—, —CH₂S(O)CH₂—, —(O)S(O)—, —CH₂(C6H₄)CH₂—, —CH₂(C6H₄)O—, a substituted or unsubstituted phenylene group, or a substituted or unsubstituted biphenylene group, wherein R is a C1 to C4 alkylene group and R′ is a C1 to C4 alkylene group.

For example, R₁ may be —ROR′OR—, —CH₂OCH₂—, a substituted or unsubstituted phenylene group, or a substituted or unsubstituted biphenylene group, and as the most specific example, R₁ may be a substituted or unsubstituted phenylene group, or a substituted or unsubstituted biphenylene group, wherein R may be a C1 to C4 alkylene group and R′ may be a C1 to C4 alkylene group.

Chemical Formula 1 may include one or more compounds selected from among the compounds represented by Chemical Formula 1A to Chemical Formula 1 E.

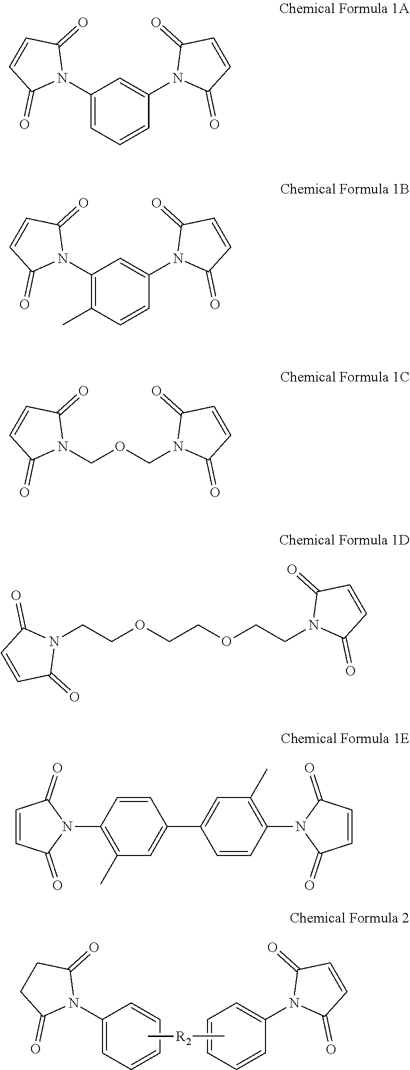

In Chemical Formula 2, R₂ is a substituted or unsubstituted C1 to C4 alkylene group, —C(O)—, —C(CH₃)₂—, —O—, —O—O—, —S—, —S—S—, —(O)S(O)—, or —S(O)—.

For example, R₂ may be a substituted or unsubstituted C1 to C4 alkylene group, —C(O)—, or —C(CH₃)₂—.

Chemical Formula 2 may include one or more compounds selected from among the compounds represented by Chemical Formula 2A to Chemical Formula 2C.

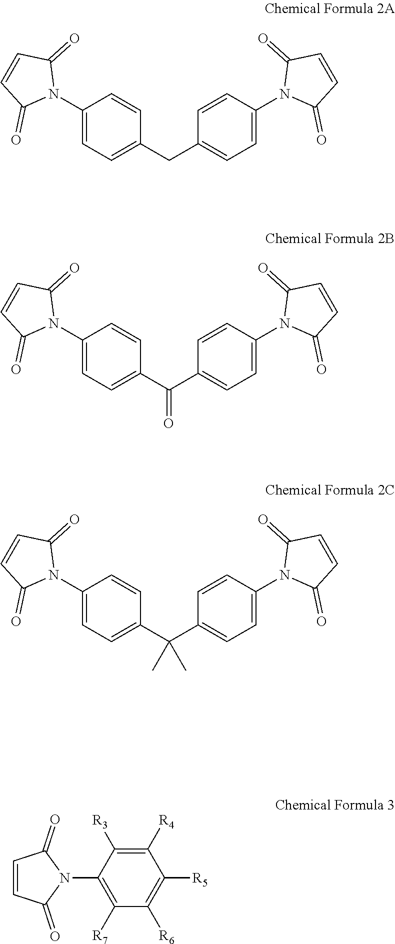

In Chemical Formula 3, R₃ to R₇ may each independently be hydrogen, a halogen, a substituted or unsubstituted C1 to C6 alkyl group, a substituted or unsubstituted C1 to C6 alkylene group, a substituted or unsubstituted C1 to C6 aryl group, a substituted or unsubstituted C1 to C6 ether group, or a substituted or unsubstituted C1 to C6 alkoxy group.

For example, R₃ to R₇ may each independently be hydrogen, a halogen, or a substituted or unsubstituted C1 to C6 alkoxy group.

Chemical Formula 3 may include one or more compounds selected from among the compounds represented by Chemical Formula 3A to Chemical Formula 3C.

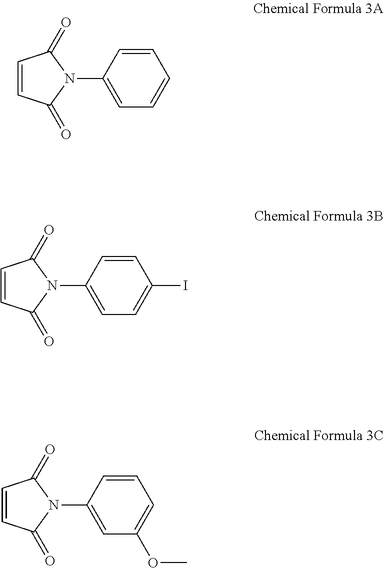

### Second Compound

The second compound is an initiator of radical polymerization and is a compound having a nitrogen-nitrogen double bond (—N═N—) at the center of the compound.

The second compound is represented by Chemical Formula 4.

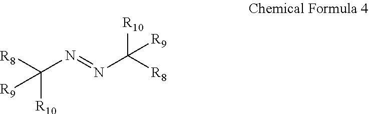

In Chemical Formula 4, R₈ to R₁₀ may each independently be hydrogen; a cyano group; a halogen; or a substituted or unsubstituted C1 to C10 hydrocarbon group including an alkyl group, a cycloalkyl group, an alkoxy group, a carboxyl group, an ester group, a carbonyl group, an amide group, a hydroxyl group, or a combination thereof, and

R₈ to R₁₀ may each exist independently, or at least two of them may be linked to form (or provide) a substituted or unsubstituted monocyclic or polycyclic aliphatic ring.

When active energy rays are irradiated to the second compound, nitrogen gas (N₂) and two molecules (2

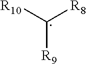

) including free radicals are generated. The molecule having the free radical initiates a radical polymerization reaction of the unsaturated bond located at the terminal end of the first compound, thereby producing a polymer utilizing the first compound as a monomer.

As an example, Chemical Formula 4 may include one or more compounds selected from among the compounds listed in Group 1. The compounds listed in Group 1 are compounds in which any one of R₈ to R₁₀ is a cyano group.

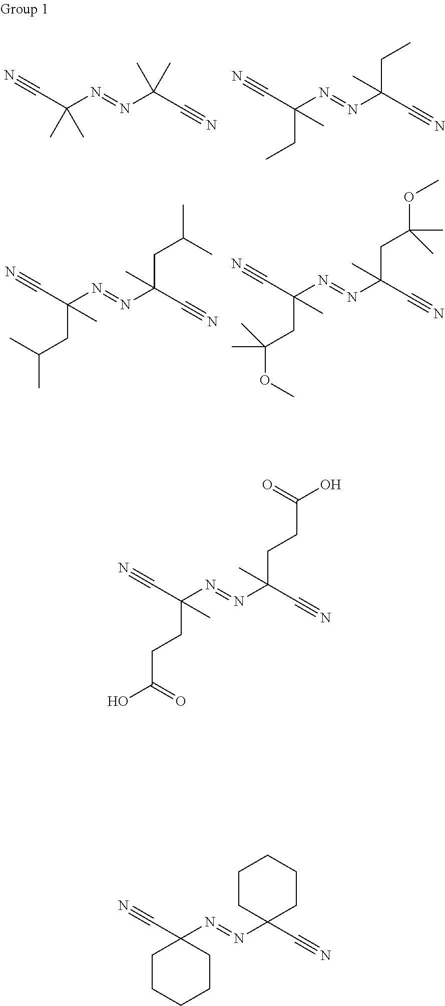

As an example, Chemical Formula 4 may include one or more compounds selected from among the compounds listed in Group 2.

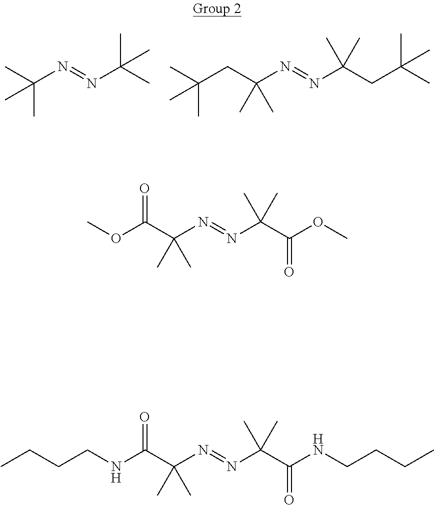

A weight ratio of the first compound and the second compound may be for example about 2:1 to about 10000:1, about 3:1 to about 10000:1, about 3:1 to about 1000:1, about 3:1 to about 500:1, about 3:1 to about 100:1, about 3:1 to about 50:1, about 3:1 to about 40:1, or about 3:1 to about 30:1.

When the weight ratio within the above range is satisfied, the thermal stability of the battery can be significantly improved.

### Other Additives

The additive may further include other additives other than those described above. The other additives may produce a synergistic effect if (e.g., when) combined with the first compound and the second compound.

The other additives may include one or more selected from among vinylene carbonate (VC), fluoroethylene carbonate (FEC), difluoroethylene carbonate (DFEC), chloroethylene carbonate (CEC), dichloroethylene carbonate (DCEC), bromoethylene carbonate (BEC), dibromoethylene carbonate (DBEC), nitroethylene carbonate, cyanoethylene carbonate, vinylethylene carbonate (VEC), succinonitrile (SN), adiponitrile (AN), 1,3,6-hexane tricyanide (HTCN), propene sultone (PST), propane sultone (PS), lithium tetrafluoroborate (LiBF₄), lithium difluorophosphate (LiPO₂F₂), and 2-fluorobiphenyl (2-FBP), but are not limited thereto.

### Electrolyte

The electrolyte for a rechargeable lithium battery includes a non-aqueous organic solvent, a lithium salt, and an electrolyte additive for a rechargeable lithium battery including a polymer obtained by polymerizing a first compound represented by Chemical Formula 1, Chemical Formula 2, or Chemical Formula 3 as a monomer; and a second compound represented by Chemical Formula 4.

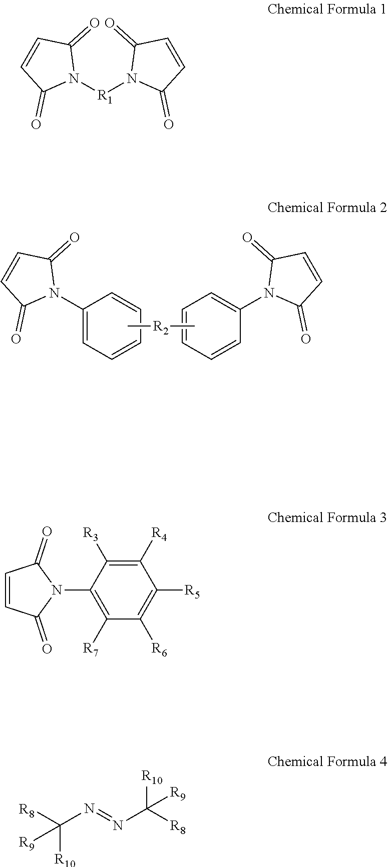

In Chemical Formula 1, R₁ is a substituted or unsubstituted C1 to C4 alkylene group, —C(O)CH₂—, —ROR′OR—, —CH₂OCH₂—, —C(O)—, —O—, —O—O—, —S—, —S—S—, —S(O)—, —CH₂S(O)CH₂—, —(O)S(O)—, —CH₂(C6H₄)CH₂—, —CH₂C6H₄O—, a substituted or unsubstituted phenylene group, or a substituted or unsubstituted biphenylene group, wherein R is a C1 to C4 alkylene group and R′ is a C1 to C4 alkylene group,
in Chemical Formula 2, R₂ is a substituted or unsubstituted C1 to C4 alkylene group, —C(O)—, —C(CH₃)₂—, —O—, —O—O—, —S—, —S—S—, —(O)S(O)—, or —S(O)—,
in Chemical Formula 3, R₃ to R₇ may each independently be hydrogen, a halogen, a substituted or unsubstituted C1 to C6 alkyl group, a substituted or unsubstituted C1 to C6 alkylene group, a substituted or unsubstituted C1 to C6 aryl group, a substituted or unsubstituted C1 to C6 ether group, or a substituted or unsubstituted C1 to C6 alkoxy group,
in Chemical Formula 4, R₈ to R₁₀ may each independently be hydrogen; a cyano group; a halogen; or a substituted or unsubstituted C1 to C10 hydrocarbon group including an alkyl group, a cycloalkyl group, an alkoxy group, a carboxyl group, an ester group, a carbonyl group, an amide group, a hydroxyl group, or a combination thereof, and
R₈ to R₁₀ may each exist independently, or at least two of them may be linked to form (or provide) a substituted or unsubstituted monocyclic or polycyclic aliphatic ring.

The first compound may be included in an amount of about 1 wt % to about 5 wt %, for example about 1 wt % to about 4 wt %, about 2 wt % to about 5 wt %, or about 2 wt % to about 4 wt %, based on a total amount of the electrolyte.

If the first compound is included in less than about 1 wt % based on the total electrolyte, it may be difficult to effectively improve the thermal stability of the battery, and if it is included in more than about 5 wt %, resistance during initial charge and discharge may increase.

The second compound may be included in an amount of about 0.0001 wt % to about 2 wt %, for example about 0.001 wt % to about 2 wt %, about 0.01 wt % to about 2 wt %, about 0.1 wt % to about 2 wt %, or about 0.1 wt % to about 1 wt %, based on a total amount of the electrolyte.

If the second compound is included in less than about 0.0001 wt % based on the total electrolyte, polymerization of the first compound may not sufficiently occur, making it difficult to effectively improve the thermal stability of the battery, and if it is included in more than about 2 wt %, a side reaction may occur with the electrode or electrolyte, causing problems with charging and discharging not occurring properly.

The weight ratio of the first compound and the second compound may be about 2:1 to about 10000:1, as an example, about 3:1 to about 10000:1, about 3:1 to about 1000:1, about 3:1 to about 500:1, about 3:1 to about 100:1, about 3:1 to about 50:1, about 3:1 to about 40:1, or about 3:1 to about 30:1.

When the weight ratio within the above ranges is satisfied, the thermal stability of the battery can be significantly improved.

Because the additive is the same as described above, detailed description is not provided here.

### Non-aqueous Organic Solvent

The non-aqueous organic solvent serves as a medium for transmitting ions taking part in the electrochemical reaction of a battery.

Non-aqueous organic solvent may include carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate. (EC), propylene carbonate (PC), butylene carbonate (BC), and/or the like.

The ester-based solvent may include methyl acetate, ethyl acetate, n-propyl acetate, dimethylacetate, methylpropionate, ethylpropionate, y-butyrolactone, decanolide, valerolactone, mevalonolactone, caprolactone, and/or the like.

The ether-based solvent may include dibutyl ether, tetraglyme, diglyme, dimethoxyethane, 2-methyltetrahydrofuran, tetrahydrofuran, and/or the like,

The ketone-based solvent may include cyclohexanone, and/or the like.

Additionally, the alcohol-based solvent may include ethanol, isopropyl alcohol, and/or the like,

The aprotic solvent may include nitriles such as R-CN (wherein R is a C2 to C20 linear, branched, or ring-structured hydrocarbon group and may include a double bond, an aromatic ring, or an ether bond), amides such as dimethylformamide, dioxolanes such as 1,3-dioxolane, sulfolanes, and/or the like.

The non-aqueous organic solvent may be utilized alone or in a mixture, and if (e.g., when) the organic solvent is utilized in a mixture, the mixture ratio may be controlled or selected in accordance with a desirable battery performance.

Additionally, in the case of the carbonate-based solvent, a mixture of cyclic carbonate and chain carbonate can be utilized. In this case, if (e.g., when) cyclic carbonate and chain carbonate are mixed and utilized in a volume ratio of about 1:1 to about 1:9, the electrolyte can exhibit excellent or suitable performance.

The non-aqueous organic solvent may further include an aromatic hydrocarbon-based organic solvent in addition to the carbonate-based solvent. At this time, a carbonate-based solvent and an aromatic hydrocarbon-based organic solvent may be mixed and utilized in a volume ratio of about 1:1 to about 30:1.

The aromatic hydrocarbon-based solvent may include aromatic hydrocarbon-based compound of Chemical Formula I.

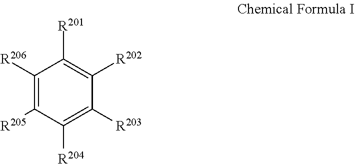

In Chemical Formula I, R²⁰¹ to R²⁰⁶ may each independently be the same or different and are selected from among hydrogen, a halogen, a C1 to C10 alkyl group, a C1 to C10 haloalkyl group, and/or a combination thereof (e.g., a suitable combination thereof).

Examples of the aromatic hydrocarbon-based solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and/or a combination thereof (e.g., a suitable combination thereof).

The electrolyte may further include vinylene carbonate, or an ethylene carbonate-based compound of Chemical Formula II to improve cycle-life of a battery as a cycle life-enhancing additive.

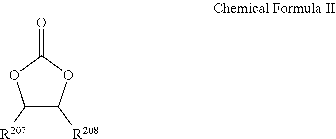

In Chemical Formula II, R²⁰⁷ and R²⁰⁸ may each independently be the same or different from each other and are selected from among hydrogen, a halogen group, a cyano group, a nitro group, and a fluorinated alkyl group having 1 to 5 carbon atoms, provided that at least one selected from among R²⁰⁷ and R²⁰⁸ is halogen, and R²⁰⁷ and R²⁰⁸ are not concurrently (e.g., simultaneously) hydrogen.

Examples of the ethylene-based carbonate-based compound may include difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, and/or the like. The amount of the additive for improving cycle-life may be utilized within an appropriate or suitable range.

### Lithium Salt

The lithium salt dissolved in the non-aqueous organic solvent supplies lithium ions in a battery, enables a basic operation of a rechargeable lithium battery, and improves transportation of the lithium ions between positive and negative electrodes.

Examples of lithium salts may include one or more selected from among LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide, LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂) (wherein x and y are natural numbers, for example integers from 1 to 20), lithium difluoro(bisoxalato) phosphate, LiCl, Lil, LiB(C₂O₄)₂ (lithium bis(oxalato) borate, LiBOB), and lithium difluoro(oxalato)borate (LiDFOB).

The lithium salt may be utilized in a concentration in a range of about 0.1 M to about 2.0 M. When the concentration of lithium salt is within the above range, the electrolyte has appropriate or suitable ionic conductivity and viscosity, and thus excellent or suitable performance may be achieved and lithium ions may move effectively.

### Rechargeable Lithium Battery

One or more embodiments provide a rechargeable lithium battery including a positive electrode including a positive electrode active material, a negative electrode including a negative electrode active material, a separator between the positive electrode and the positive electrode, and the aforementioned electrolyte.

The electrolyte is the same as described above and thus, detailed description thereof is not provided herein.

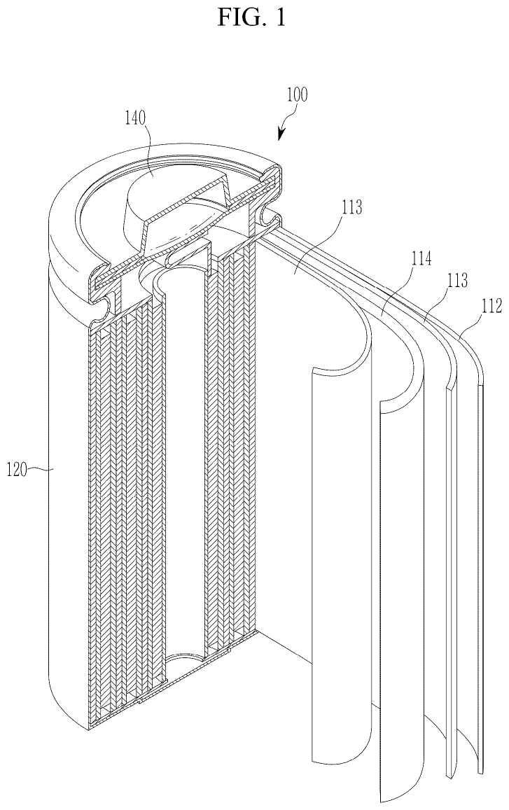

FIG. 1 is a schematic view showing a rechargeable lithium battery according to one or more embodiments. Referring to FIG. 1, the rechargeable lithium battery 100 includes a battery cell including a positive electrode 114, a negative electrode 112 opposite the positive electrode 114, and a separator 113 between the positive electrode 114 and the negative electrode 112, and an electrolyte for a rechargeable lithium battery impregnating the positive electrode 114, the negative electrode 112, and the separator 113, a battery container 120 housing the battery cell, and a sealing member 140 that seals the battery container 120.

### Positive Electrode

The positive electrode may include a current collector and a positive electrode active material layer located on the current collector. The positive electrode active material layer includes a positive electrode active material, and may optionally further include a binder and/or a conductive material.

The positive electrode active material can be applied without limitation as long as it is commonly utilized in rechargeable lithium batteries. For example, the positive electrode active material may be a compound capable of intercalating and deintercalating lithium, and may include a compound represented by any one of the following chemical formulas:
LiₐA_{1-b}X_{b}D₂ (0.90≤a<1.8, 0≤b≤0.5);
LiₐA_{1-b}X_{b}O_{2-c}D_{c} (0.90≤a≤1.8, 0≤5 b≤0.5, 0≤c≤0.05);
LiₐE_{1-b}X_{b}O_{2-c}D_{c} (0.90≤a≤1.8, 0<≤b≤0.5, 0<≤c≤0.05);
LiₐE_{2-b}X_{b}O_{4-c}D_{c} (0.90≤a≤1.8, 0<≤b≤0.5, 0<≤c≤0.05);
LiₐNi_{1-b-c}Co_{b}X_{c}Dₐ (0.90≤a≤1.8, 0<≤b≤0.5, 0≤c≤0.5, 0<a≤2);
LiₐNi_{1-b-c}Co_{b}X_{c}O₂₋ₐTₐ (0.90≤a≤1.8, 0≤b≤0.5, 0≤c≤0.05, 0<a<2);
LiₐNi_{1-b-c}Co_{b}X_{c}O₂₋ₐT₂ (0.90≤a≤1.8, 0≤b≤0.5, 0≤c≤0.05, 0<a<2);
LiₐNi_{1-b-c}Mn_{b}X_{c}Dₐ (0.90≤a≤1.8, 0≤b≤0.5, 0≤c≤0.05, 0<a<2);
LiₐNi_{1-b-c}Mn_{b}X_{c}O₂₋ₐTₐ (0.90≤a≤1.8, 0≤b≤0.5, 0≤c≤0.05, 0<a<2);
LiₐNi_{1-b-c}Mn_{b}X_{c}O₂₋ₐT₂ (0.90≤a≤1.8, 0≤b≤0.5, 0≤c≤0.05, 0<a<2);
LiₐNi_{b}E_{c}G_{d}O₂ (0.90≤a≤1.8, 0≤b≤0.9, 0≤c≤0.5, 0.001≤d≤0.1);
LiₐNi_{b}Co_{c}Mn_{d}GeO₂ (0.90≤a≤1.8, 0≤b≤0.9, 0≤c≤0.5, 0≤d≤0.5, 0.001≤e≤0.1);
LiₐNiG_{b}O₂ (0.90≤a<1.8, 0.001≤b≤0.1);
LiₐCoG_{b}O₂ (0.90≤a≤1.8, 0.001≤b≤0.1);
LiₐMn_{1-b}G_{b}O₂ (0.90≤a≤1.8, 0.001≤b≤0.1);
LiₐMn₂G_{b}O₄ (0.90≤a≤1.8, 0.001≤b≤0.1);
LiₐMn_{1-g}G_{g}PO₄ (0.90≤a≤1.8, 0≤g≤0.5);
QO₂; QS₂; LiQS₂;
V₂O₅; LiV₂O₅;
LiZO₂;
LiNiVO₄;
Li_{(3-f)}J₂(PO₄)₃ (0≤f≤2);
Li_{(3-f)}Fe₂(PO₄)₃ (0≤f≤2);
LiₐFePO₄ (0.90≤a≤1.8).

In the above chemical formulas, A is selected from among Ni, Co, Mn, and/or a combination thereof (e.g., a suitable combination thereof); X is selected from among Al, Ni, Co, Mn, Cr, Fe, Mg, Sr, V, rare earth elements, and/or a combination thereof (e.g., a suitable combination thereof); D is selected from among 0, F, S, P, and/or a combination thereof (e.g., a suitable combination thereof); E is selected from among Co, Mn, and/or a combination thereof; T is of (e.g., selected from among) F, S, P, and/or a (e.g., any suitable)combination thereof (e.g., a suitable combination thereof); G is selected from among Al, Cr, Mn, Fe, Mg, La, Ce, Sr, V, and/or a combination thereof (e.g., a suitable combination thereof); Q is selected from among Ti, Mo, Mn, and/or a combination thereof (e.g., a suitable combination thereof); Z is selected from among Cr, V, Fe, Sc, Y, and/or a combination thereof (e.g., a suitable combination thereof); and J is selected from among V, Cr, Mn, Co, Ni, Cu, and/or a combination thereof (e.g., a suitable combination thereof).

The positive electrode active material may include, for example, lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), lithium iron phosphate (LFP), and/or the like.

In one or more embodiments, the positive electrode active material may include lithium cobalt-based oxide. When utilized with the aforementioned electrolyte, a positive electrode utilizing lithium cobalt-based oxide as a positive electrode active material can exert a synergistic effect in a 4.5V relatively high-voltage design or fast charging system to suppress or reduce battery resistance and improve overall battery performance.

For example, the lithium cobalt-based oxide may be represented by Chemical Formula 5.

Liₐ₁Coₓ₁M¹₍₁₋ₓ₁₎O₂ Chemical Formula 5

In Chemical Formula 5, 0.9≤a1≤1.8, and 0.7≤x1≤1, and M¹ is one or more elements selected from among Al, B, Ba, Ca, Ce, Cr, Cu, F, Fe, Mg, Mn, Mo, Ni, P, S, Se, Si, Sr, Ti, V, W, Y, Zn and Zr.

In Chemical Formula 5, x1 represents the molar content (e.g., amount) of cobalt and may be, for example, 0.8<x1<1, 0.9<x1≤1, or 0.95≤x1≤1.

An average particle diameter (D₅₀) of the positive electrode active material may be about 1 μm to about 25 μm, for example, about 3 μm to about 25 μm, about 5 μm to about 25 μm, about 5 μm to about 20 μm, about 8 μm to about 20 μm, or about 10 μm to about 18 μm. The positive electrode active material having this particle size range can be harmoniously mixed with other components within the positive electrode active material layer and can achieve relatively high capacity and relatively high energy density. Herein, the average particle diameter (D₅₀) is measured with a particle size analyzer utilizing a laser diffraction method, and may refer to the diameter of a particle with a cumulative volume of 50 volume % in the particle size distribution.

The positive electrode active material may be in the form of secondary particles made by agglomerating a plurality of primary particles, or may be in the form of single particles. Additionally, the positive electrode active material may be spherical or close to a spherical shape, or may be polyhedral or amorphous.

The positive electrode active material layer may include binder. The binder improves binding properties of positive electrode active material particles with one another and with a current collector. Examples thereof may be polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but are not limited thereto.

The content (e.g., amount) of the binder in the positive electrode active material layer may be approximately about 0.5 wt % to about 5 wt % based on a total weight of the positive electrode active material layer.

The positive electrode active material layer may include conductive material. The conductive material may be utilized to impart conductivity (e.g., electrical conductivity) to the electrode and any material that does not cause chemical change (e.g., does not cause an undesirable chemical change in the rechargeable lithium battery) and conducts electrons can be utilized in the battery. Examples of the conductive material may include a carbon-based material such as natural graphite, artificial graphite, carbon black, acetylene black, ketjen black, a carbon fiber, a carbon nanofiber, and a carbon nanotube; a metal-based material containing copper, nickel, aluminum, silver, and/or the like, in a form of a metal powder or a metal fiber; a conductive polymer such as a polyphenylene derivative; and/or a mixture thereof (e.g., a suitable mixture thereof).

The content (e.g., amount) of the conductive material in the positive electrode active material layer may be about 1 wt % to about 5 wt % based on a total weight of the positive electrode active material layer.

Aluminum foil may be utilized as the positive electrode current collector, but the present disclosure is not limited thereto.

### Negative Electrode

A negative electrode for a rechargeable lithium battery includes a current collector and a negative electrode active material layer on the current collector. The negative electrode active material layer includes a negative electrode active material and may further include a binder and/or a conductive material (e.g., an electron conductor).

The negative electrode active material may be a material that reversibly intercalates/deintercalates lithium ions, a lithium metal, a lithium metal alloy, a material capable of doping and dedoping lithium, or a transition metal oxide.

The material that reversibly intercalates/deintercalates lithium ions may include a carbon-based negative electrode active material, for example, crystalline carbon, amorphous carbon and/or a combination thereof (e.g., a suitable combination thereof). The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and/or the like.

The lithium metal alloy may include lithium and a metal selected from among Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x≤2), a Si-Q alloy (wherein Q is an alkali metal, an alkaline-earth metal, a Group 13 element, a Group 14 element, a Group 15 element, a Group 16 element, a transition metal, a rare earth element, and/or a combination thereof (e.g., a suitable combination thereof), but not Si) and the Sn-based negative electrode active material may include Sn, SnOₓ (0<x≤2) (e.g., SnO₂), a Sn—R alloy (wherein R is an alkali metal, an alkaline-earth metal, a Group 13 element, a Group 14 element, a Group 15 element, a Group 16 element, a transition metal, a rare earth element, and/or a combination thereof (e.g., a suitable combination thereof), but not Sn). At least one of these materials may be mixed with SiO₂. The elements Q and R may be selected from among Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and/or a combination thereof (e.g., a suitable combination thereof).

The silicon-carbon composite may be, for example, a silicon-carbon composite including a core including crystalline carbon and silicon particles and an amorphous carbon coating layer arranged on the surface of the core. The crystalline carbon may be artificial graphite, natural graphite, and/or a combination thereof (e.g., a suitable combination thereof). The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In this case, a content (e.g., amount) of silicon may be about 10 wt % to about 50 wt % based on a total weight of the silicon-carbon composite. In one or more embodiments, a content (e.g., amount) of the crystalline carbon may be about 10 wt % to about 70 wt % based on a total weight of the silicon-carbon composite, and a content (e.g., amount) of the amorphous carbon may be about 20 wt % to about 40 wt % based on a total weight of the silicon-carbon composite. In one or more embodiments, a thickness of the amorphous carbon coating layer may be about 5 nm to about 100 nm. An average particle diameter (D₅₀) of the silicon particles may be about 10 nm to about 20 μm. The average particle diameter (D₅₀) of the silicon particles may be about 10 nm to about 200 nm. The silicon particles may exist in an oxidized form, and in this case, an atomic content (e.g., amount) ratio of Si:O in the silicon particles indicating a degree of oxidation may be a weight ratio of about 99:1 to about 33:67. The silicon particles may be SiOₓ particles, and in this case, the range of x in SiOₓ may be greater than 0 and less than about 2. In the present specification, unless otherwise defined, an average particle diameter (D₅₀) indicates a particle where an accumulated volume is about 50 volume % in a particle distribution.

The Si-based negative electrode active material or Sn-based negative electrode active material may be mixed with the carbon-based negative electrode active material. When the Si-based negative electrode active material or Sn-based negative electrode active material and the carbon-based negative electrode active material are mixed and utilized, the mixing ratio may be a weight ratio of about 1:99 to about 90:10.

In the negative electrode active material layer, the negative electrode active material may be included in an amount of about 95 wt % to about 99 wt % based on a total weight of the negative electrode active material layer.

In one or more embodiments, the negative electrode active material layer further includes a binder, and may optionally further include a conductive material. A content (e.g., amount) of the binder in the negative electrode active material layer may be about 1 wt % to about 5 wt % based on a total weight of the negative electrode active material layer. In one or more embodiments, if (e.g., when) the conductive material is further included, the negative electrode active material layer may include about 90 wt % to about 98 wt % of the negative electrode active material, about 1 wt % to about 5 wt % of the binder, and about 1 wt % to about 5 wt % of the conductive material.

The binder serves to well adhere the negative electrode active material particles to each other and also to adhere the negative electrode active material to the current collector. The binder may be a water-insoluble binder, a water-soluble binder, and/or a combination thereof (e.g., a suitable combination thereof).

The non-water-soluble binder may include polyvinylchloride, carboxylated polyvinylchloride, polyvinylfluoride, an ethylene oxide-containing polymer, ethylene propylene copolymer, polystyrene, polyvinylpyrrolidone, polyurethane, polytetrafluoroethylene, polyvinylidene fluoride, polyethylene, polypropylene, polyamideimide, polyimide, and/or a combination thereof (e.g., a suitable combination thereof).

The water-soluble binder may include a rubber binder or a polymer resin binder. The rubber binder may be selected from among a styrene-butadiene rubber, an acrylated styrene-butadiene rubber, an acrylonitrile-butadiene rubber, an acrylic rubber, a butyl rubber, a fluororubber, and/or a combination thereof (e.g., a suitable combination thereof). The polymer resin binder may be selected from among polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and/or a combination thereof (e.g., a suitable combination thereof).

When a water-soluble binder is utilized as the negative binder, a cellulose-based compound capable of imparting viscosity may be further included as a kind of thickener. As the cellulose-based compound, one or more of carboxymethyl cellulose, hydroxypropylmethyl cellulose, methyl cellulose, or alkali metal salts thereof may be mixed and utilized. The alkali metal may be Na, K, or Li. A content (e.g., amount) of the thickener utilized may be about 0.1 parts by weight to about 3 parts by weight based on about 100 parts by weight of the negative electrode active material.

The conductive material is included to provide electrode conductivity and any electrically conductive material may be utilized as a conductive material unless it causes a chemical change. Examples of the conductive material include a carbon-based material such as natural graphite, artificial graphite, carbon black, acetylene black, ketjen black, a carbon fiber, a carbon nanofiber, a carbon nanotube, and/or the like; a metal-based material of a metal powder or a metal fiber including copper, nickel, aluminum, silver, and/or the like; a conductive polymer such as a polyphenylene derivative; and/or a mixture thereof (e.g., a suitable mixture thereof).

The negative electrode current collector may include one selected from among a copper foil, a nickel foil, a stainless steel foil, a titanium foil, a nickel foam, a copper foam, a polymer substrate coated with a conductive metal, and/or a combination thereof (e.g., a suitable combination thereof).

### Separator

The separator 113 separates a positive electrode 114 and a negative electrode 112 and provides a transporting passage for lithium ions and may be any generally-utilized separator in a lithium ion battery. The separator may have relatively low resistance to ion transport and excellent or suitable impregnation for an electrolyte. For example, the separator may include a glass fiber, polyester, polyethylene, polypropylene, polytetrafluoroethylene, and/or a combination thereof and may have a form of a non-woven fabric or a woven fabric. For example, in a lithium ion battery, a polyolefin-based polymer separator such as polyethylene and polypropylene is mainly utilized. In order to ensure the heat resistance or mechanical strength, a coated separator including a ceramic component or a polymer material may be utilized. Optionally, it may have a mono-layered or multi-layered structure.

Rechargeable lithium batteries may be classified as lithium ion batteries, lithium ion polymer batteries, and lithium polymer batteries according to the presence of a separator and the type or kind of electrolyte utilized therein. The rechargeable lithium batteries may have a variety of shapes and sizes, and include cylindrical, prismatic, coin, or pouch-type or kind batteries, and may be thin film batteries or may be rather bulky in size. Structures and manufacturing methods for these batteries pertaining to this disclosure are suitable in the art.

Hereinafter, examples of present disclosure and comparative examples are described. However, the examples are for the purpose of illustration and are not to be construed as limiting present disclosure.

### EXAMPLES

### Example 1

(Hereinafter, in a composition of the electrolyte, “wt %” is based on a total content (e.g., amount) of an electrolyte (a lithium salt+a non-aqueous organic solvent+additives, and/or the like.))

The electrolyte was prepared by mixing ethylene carbonate (EC), ethylmethyl carbonate (EMC), dimethyl carbonate (DMC) in a volume ratio of about 20:10:70 to prepare a non-aqueous organic solvent, dissolving about 1.5 M of a LiPF₆ lithium salt in the non-aqueous organic solvent, and adding about 2 wt % of a first compound represented by Chemical Formula 2A (1,1′-(methylenedi-4,1-phenylene)bismaleimide) and about 0.1 wt % of a second compound represented by Chemical Formula 4a (2,2′-azobis(isobutyronitrile)) thereto.

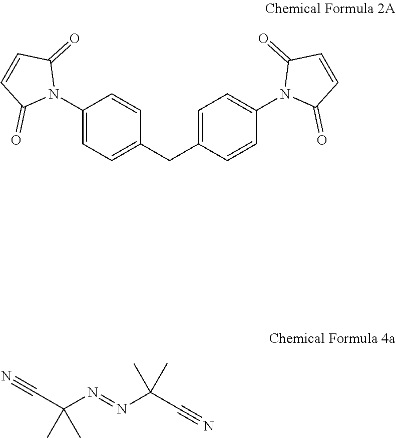 [SMILES: O=C1C=CC(=O)N1c1ccc(Cc2ccc(N3C(=O)C=CC3=O)cc2)cc1 ; CC(C)(C#N)/N=N/C(C)(C)C#N]

LiCoO₂ as a positive electrode active material, polyvinylidene fluoride as a binder, and ketjen black as a conductive material were mixed in a weight ratio of about 97:2:1 and then, dispersed in N-methyl pyrrolidone, preparing a positive electrode active material slurry. The positive electrode active material slurry was coated on a 14 μm-thick Al foil current collector and then, dried at about 110° C. and compressed, manufacturing a positive electrode.

Artificial graphite as a negative electrode active material, a styrene-butadiene rubber as a binder, and carboxymethyl cellulose as a thickener were in a weight ratio of about 97:1:2 and then, dispersing the mixture in distilled water, preparing a negative electrode active material slurry. The negative electrode active material slurry was coated on an about 10 μm-thick Cu foil current collector and then, dried at about 100° C. and compressed, manufacturing a negative electrode.

Subsequently, an about 25 μm-thick separator with a polyethylene-polypropylene multi-layer structure was interposed between the positive and negative electrodes to obtain an electrode assembly, the electrode assembly was housed into a circular-type or kind battery case, and the prepared electrolyte is injected thereinto, manufacturing a rechargeable lithium battery cell according to Example 1.

### Examples 2 to 18

Each rechargeable lithium battery cell of Examples 2 to 18 was manufactured in substantially the same manner as in Example 1 except that wt % of the first compound and types (kinds) and wt % of the second compound were changed as shown in Table 1.

### Comparative Example 1

A rechargeable lithium battery cell was manufactured in substantially the same manner as in Example 1 except that the additives were not included.

### Comparative Examples 2 to 4

A rechargeable lithium battery cell was manufactured in substantially the same manner as in Example 1 except that the second compound was excluded, but the first compound was included in wt % shown in Table 1.

### Comparative Examples 5 to 7

Each rechargeable lithium battery cell was manufactured in substantially the same manner as in Example 1 except that the first compound was excluded, but the second compound was included in wt % shown in Table 1.

TABLE 1

| | | | | | Weight ratio |
|---|---|---|---|---|---|
| | | | | | of first |
| | First compound | | Second compound | | compound:second |
| | Type | wt % | Type | wt % | compound Ratio |
| Comp. | — | — | — | — | — |
| Ex. 1 | | | | | |
| Comp. | Chemical | 2 wt % | — | — | — |
| Ex. 2 | Formula | | | | |
| Comp. | 2A | 3 wt % | — | — | — |
| Ex. 3 | | | | | |
| Comp. | | 4 wt % | — | — | — |
| Ex. 4 | | | | | |
| Comp. Ex. 5 | — | — | 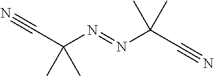 | 0.1 wt % | — |
| Comp. | — | — | | 0.5 | — |
| Ex. 6 | | | | wt | |
| | | | | % | |
| Comp. | — | — | | 1.0 | — |
| Ex. 7 | | | | wt | |
| | | | | % | |
| Ex. 1 | Chemical Formula 2A | 2 wt % | 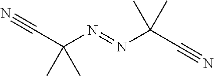 | 0.1 wt % | 20:1 |
| Ex. 2 | | | | 0.5 | 4:1 |
| | | | | wt | |
| | | | | % | |
| Ex. 3 | | | | 1.0 | 2:1 |
| | | | | wt | |
| | | | | % | |
| Ex. 4 | | 3 wt % | | 0.1 | 30:1 |
| | | | | wt | |
| | | | | % | |
| Ex. 5 | | | | 0.5 | 6:1 |
| | | | | wt | |
| | | | | % | |
| Ex. 6 | | | | 1.0 | 3:1 |
| | | | | wt | |
| | | | | % | |
| Ex. 7 | | 4 wt % | | 0.1 | 40:1 |
| | | | | wt | |
| | | | | % | |
| Ex. 8 | | | | 0.5 | 8:1 |
| | | | | wt | |
| | | | | % | |
| Ex. 9 | | | | 1.0 | 4:1 |
| | | | | wt | |
| | | | | % | |
| Ex. 10 | | 3 wt % | 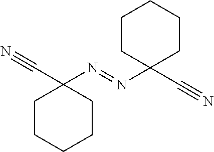 [SMILES: N#CC1(/N=N/C2(C#N)CCCCC2)CCCCC1] | 1.0 wt % | 3:1 |
| Ex. 11 | | | 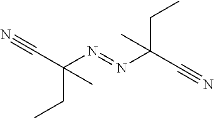 | | |
| Ex. 12 | | | 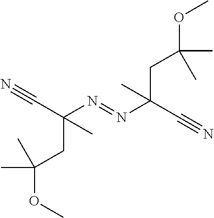 [SMILES: COC(C)(C)CC(C)(C#N)/N=N/C(C)(C#N)CC(C)(C)OC] | | |
| Ex. 13 | | | 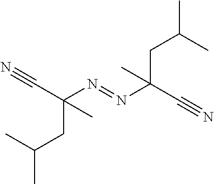 [SMILES: CC(C)CC(C)(C#N)/N=N/C(C)(C#N)CC(C)C] | | |
| Ex. 14 | | | 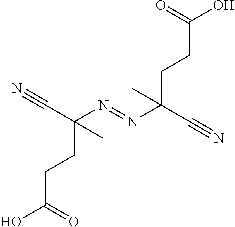 [SMILES: CC(C#N)(CCC(=O)O)/N=N/C(C)(C#N)CCC(=O)O] | | |
| Ex. 15 | | | 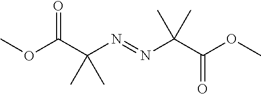 | | |
| Ex. 16 | | | 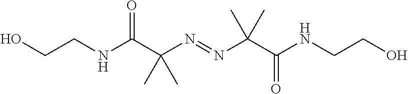 [SMILES: CC(C)(/N=N/C(C)(C)C(=O)NCCO)C(=O)NCCO] | | |
| Ex. 17 | | | 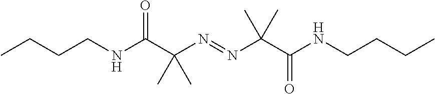 [SMILES: CCCCNC(=O)C(C)(C)/N=N/C(C)(C)C(=O)NCCCC] | | |
| Ex. 18 | | | 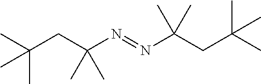 [SMILES: CC(C)(C)CC(C)(C)/N=N/C(C)(C)CC(C)(C)C] | | |

### Experimental Example 1: Heat Exposure Evaluation

The rechargeable lithium battery cells of Examples 1 to 18 and Comparative Examples 1 to 7 were placed in a chamber and then, examined with respect to changes by increasing a temperature to about 140° C., about 141° C., about 142° C., and about 143° C. at about 5° C./min and allowing them to stand at the temperature for about 1 hour, and the results are shown in Table 2.

After conducting the experiment three times in total, if (e.g., when) no thermal runaway occurred, while maintaining the temperature, OK was given, but if (e.g., when) there occurred rapid thermal runaway due to the relatively high temperature exposure, Fail was given.

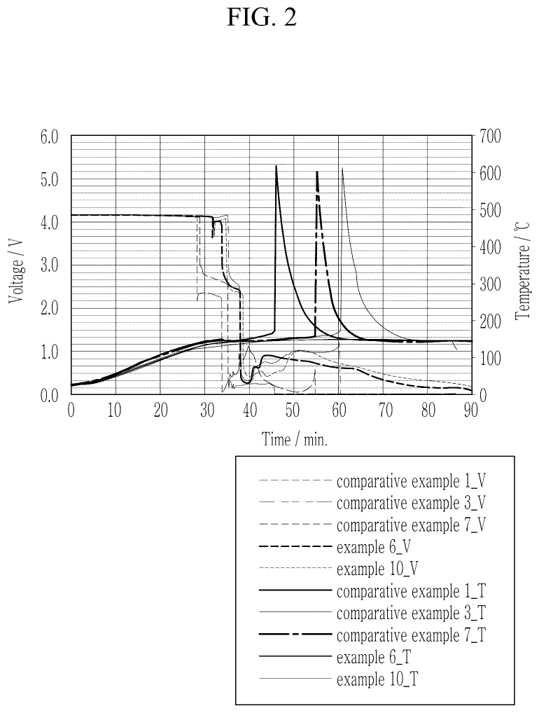

In one or more embodiments, FIG. 2 is a graph showing a temperature change and a voltage change according to thermal exposure at about 143° C. in some examples and some comparative examples.

In FIG. 2, a dotted line shows a voltage change according to time, and a solid line shows a temperature change according to time.

TABLE 2

| | Temperature | | | |
|---|---|---|---|---|
| | 140° C. | 141° C. | 142° C. | 143° C. |
| Comp. Ex. 1 | 3FAIL/3 | | | |
| Comp. Ex. 2 | 3FAIL/3 | | | |
| Comp. Ex. 3 | 1FAIL/3 | 3FAIL/3 | | 3FAIL/3 |
| Comp. Ex. 4 | 1FAIL/3 | 3FAIL/3 | | |
| Comp. Ex. 5 | 3FAIL/3 | | | |
| Comp. Ex. 6 | 3FAIL/3 | | | |
| Comp. Ex. 7 | 3FAIL/3 | | | 3FAIL/3 |
| Ex. 1 | 3OK/3 | 3OK/3 | 1FAIL/3 | |
| Ex. 2 | 3OK/3 | 2FAIL/3 | | |
| Ex. 3 | 3OK/3 | 3FAIL/3 | | |
| Ex. 4 | 3OK/3 | 3OK/3 | 3OK/3 | 3OK/3 |
| Ex. 5 | 3OK/3 | 3OK/3 | 3OK/3 | 1FAIL/3 |
| Ex. 6 | 3OK/3 | 3OK/3 | 3OK/3 | 3OK/3 |
| Ex. 7 | 3OK/3 | 3OK/3 | 3OK/3 | 2FAIL/3 |
| Ex. 8 | 3OK/3 | 3OK/3 | 3OK/3 | 3OK/3 |
| Ex. 9 | 3OK/3 | 3OK/3 | 3OK/3 | 3OK/3 |
| Ex. 10 | 3OK/3 | 3OK/3 | 3OK/3 | 3OK/3 |
| Ex. 11 | 3OK/3 | 3OK/3 | 3OK/3 | 3OK/3 |
| Ex. 12 | 3OK/3 | 3OK/3 | 3OK/3 | 2FAIL/3 |
| Ex. 13 | 3OK/3 | 3OK/3 | 3OK/3 | 1FAIL/3 |
| Ex. 14 | 3OK/3 | 2FAIL/3 | | |
| Ex. 15 | 3OK/3 | 3OK/3 | 3OK/3 | 3OK/3 |
| Ex. 16 | 3OK/3 | 3OK/3 | 3OK/3 | 2FAIL/3 |
| Ex. 17 | 3OK/3 | 3OK/3 | 1FAIL/3 | |
| Ex. 18 | 3OK/3 | 3OK/3 | 2FAIL/3 | |

Referring to Table 2, in each of the rechargeable lithium battery cells of Comparative Examples 1 to 7, thermal runaway was observed at heat exposure of about 140 00, but in Examples 1 to 18, no thermal runaway was observed at the heat exposure of about 140 00. In addition, in each of the rechargeable lithium battery cells of Examples 4, 6, 8 to 11, and 15, no thermal runaway was observed at the heat exposure of about 143 00.

Referring to FIG. 2, in the rechargeable lithium battery cells of Comparative Examples 1, 3, and 7 and Examples 6 and 10, a sharp voltage drop was observed. In general, if (e.g., when) a cylindrical battery is suddenly exposed to a relatively high temperature, gas is generated and increases its internal pressure, which operates a battery protection circuit, operates a current interrupt device (CID), and thus causes a sharp voltage drop. Accordingly, the sharp voltage drop of the rechargeable lithium battery cells of Comparative Examples 1, 3, and 7 and Examples 6 and 10 confirmed that the current interrupt device (CID) was activated by gas generation due to the relatively high temperature exposure.

For example, even though the rechargeable lithium battery cells of Examples 6 and 10 were exposed to the temperature of about 143° C., no thermal runaway occurred, while maintaining the temperature of about 143° C.

In contrast, there occurred sudden thermal runaway of about 600° C. or more respectively at about 46 minutes in Comparative Example 1, at about 55 minutes in Comparative Example 3, and at about 61 minutes in Comparative Example 7.

### Experimental Example 2: Evaluation of High-temperature (60° C.) Storage Characteristics

The rechargeable lithium battery cells of Examples 1, 3, and 10 were allowed to stand for about 10, about 20, and about 30 days at a relatively high temperature of about 60° C. in a state of charge (SOC=about 100%) to evaluate relatively high temperature storage characteristics.

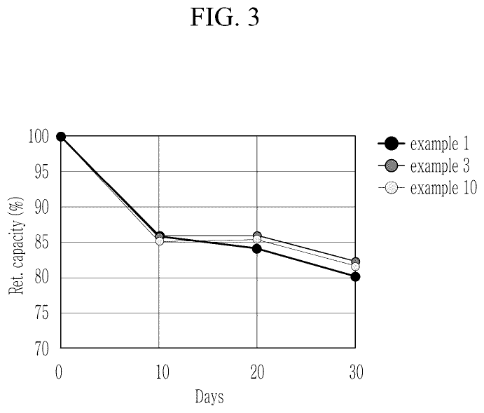

For example, a percentage of each storage capacity after allowed to stand for about 10, about 20, and about 30 days to initial capacity was calculated as a capacity retention rate (%), and the results are shown in FIG. 3.

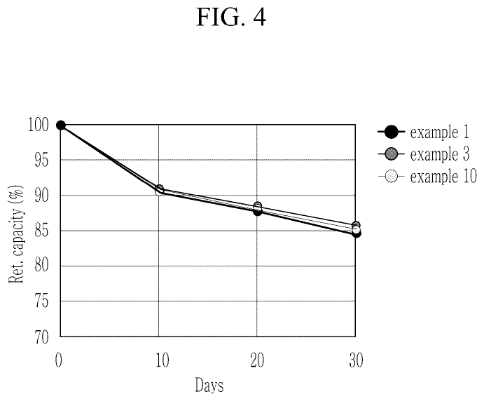

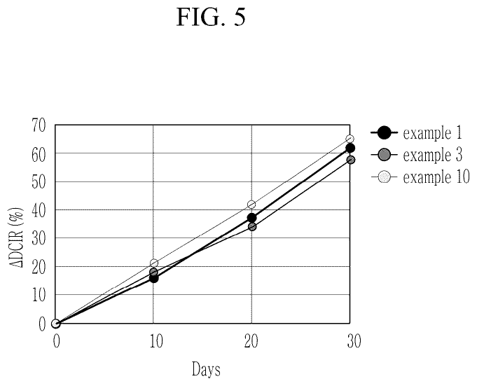

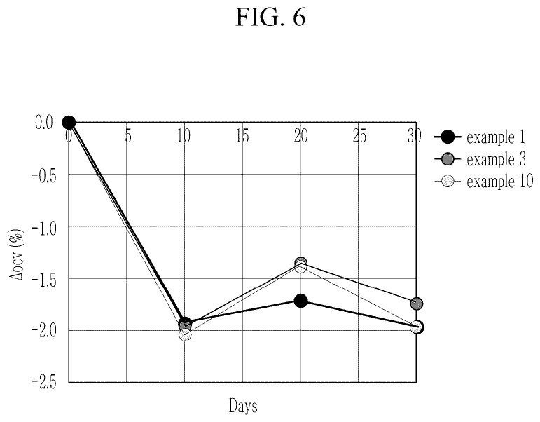

In one or more embodiments, a percentage of each recovery capacity (%) after allowed to stand for about 10, about 20, and about 30 days to the initial capacity was calculated as a capacity recovery rate (%), and the results are shown in FIG. 4. Furthermore, a DC internal resistance increase rate (ADCIR, %) of DC internal resistance after allowed to stand for about 10, about 20, and about 30 days to initial resistance was calculated, and the results are shown in FIG. 5. In one or more embodiments, an open circuit voltage variation ratio (AOCV, %) of an open circuit voltage (OCV) after allowed to stand for about 10, about 20, and about 30 days to an initial voltage was calculated, and the results are shown in FIG. 6.

Referring to FIGS. 3 to 6, the rechargeable lithium battery cells of Examples 1, 3, and 10 exhibited excellent or suitable storage characteristics at a relatively high temperature.

### Experimental Example 3: Room-temperature (25° C.) Cycle-life Evaluation

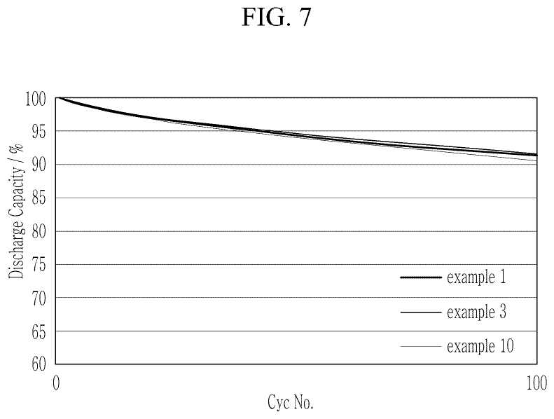

The rechargeable lithium battery cells of Examples 1, 3, and 10 were charged at constant current-constant voltage of about 1.6 C and about 4.2 V with a cut-off at about 0.04 C and allowed to stand for about 10 minutes and then, discharged at a constant current of about 1.6 C with a cut-off at about 2.5 V and allowed to stand for about 10 minutes at room temperature (about 25° C.), which were 100 times repeated to measure discharge capacity. A capacity retention rate (%) of discharge capacity at the 100^{th} cycle to discharge capacity at the 1^{st} cycle was calculated, and the results are shown in FIG. 7.

Referring to FIG. 7, the rechargeable lithium battery cells of Example 1, 3, and 10 each exhibited an excellent or suitable capacity retention rate (%) of about 90% or more even if (e.g., when) 100 cycles were driven at room temperature.

In present disclosure, “not include a or any ‘component’”, “exclude a or any ‘component’”, “‘component’-free”, and/or the like refers to that the “component” not being added, selected or utilized as a component in the composition or compound, but the “component” of less than a suitable amount may still be included due to other impurities and/or external factors.

A battery management system (BMS) device, and/or any other relevant devices or components according to embodiments of the present disclosure described herein may be implemented utilizing any suitable hardware, firmware (e.g. an application-specific integrated circuit), software, or a combination of software, firmware, and hardware. For example, the one or more suitable components of the device may be formed on one integrated circuit (IC) chip or on separate IC chips. Further, the one or more suitable components of the device may be implemented on a flexible printed circuit film, a tape carrier package (TCP), a printed circuit board (PCB), or formed on one substrate. Further, the one or more suitable components of the device may be a process or thread, running on one or more processors, in one or more computing devices, executing computer program instructions and interacting with other system components for performing the one or more suitable functionalities described herein. The computer program instructions are stored in a memory which may be implemented in a computing device utilizing a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of one or more suitable computing devices may be combined or integrated into a single computing device, or the functionality of a particular computing device may be distributed across one or more other computing devices without departing from the scope of the present disclosure.

In present disclosure, “not include a or any ‘component’” “exclude a or any ‘component’”, “‘component’-free”, and/or the like refers to that the “component” not being added, selected or utilized as a component in the composition/structure, but the “component” of less than a suitable amount may still be included due to other impurities and/or external factors.

While this invention has been described in connection with what is presently considered to be practical example embodiments, it is to be understood that present disclosure is not limited to the disclosed embodiments. In contrast, it is intended to cover one or more suitable modifications and equivalent arrangements included within the spirit and scope of the appended claims, and equivalents thereof.

Reference Numerals

| | |
|---|---|
| 100: rechargeable lithium battery | 112: negative electrode |
| 113: separator | 114: positive electrode |
| 120: battery case | 140: sealing member |

What is claimed is:

1. An electrolyte additive comprising
a polymer obtained by polymerizing a first compound represented by Chemical Formula 1, Chemical Formula 2, or Chemical Formula 3 as a monomer; and
a second compound represented by Chemical Formula 4: 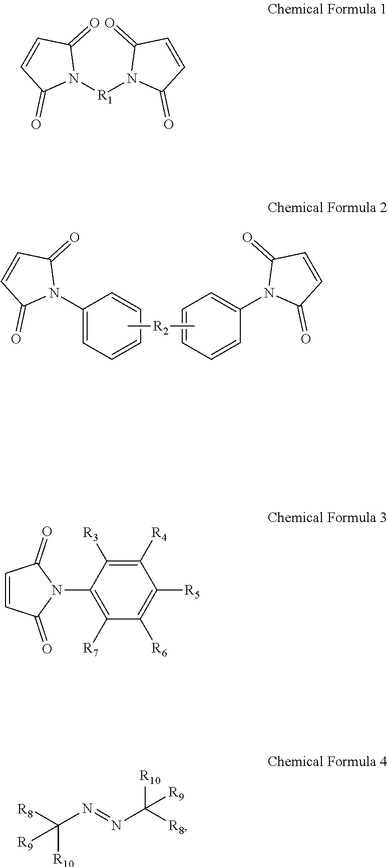
in Chemical Formula 1, R₁ is a substituted or unsubstituted C1 to C4 alkylene group, —C(O)CH₂—, —ROR′OR—, —CH₂OCH₂—, —C(O)—, —O—, —O—O—, —S—, —S—S—, —S(O)—, —CH₂S(O)CH₂—, —(O)S(O)—, —CH₂(C6H₄)CH₂—, —CH₂(C6H₄)O—, a substituted or unsubstituted phenylene group, or a substituted or unsubstituted biphenylene group, R being a C1 to C4 alkylene group and R′ being a C1 to C4 alkylene group,
in Chemical Formula 2, R₂ is a substituted or unsubstituted C1 to C4 alkylene group, —C(O)—, —C(CH₃)₂—, —O—, —O—O—, —S—, —S—S—, —(O)S(O)—, or —S(O)—,
in Chemical Formula 3, R₃ to R₇ are each independently hydrogen, a halogen, a substituted or unsubstituted C1 to C6 alkyl group, a substituted or unsubstituted C1 to C6 alkylene group, a substituted or unsubstituted C1 to C6 aryl group, a substituted or unsubstituted C1 to C6 ether group, or a substituted or unsubstituted C1 to C6 alkoxy group, and
in Chemical Formula 4, R₈ to R₁₀ are each independently hydrogen; cyano group; a halogen; or a substituted or unsubstituted C1 to C10 hydrocarbon group comprising an alkyl group, a cycloalkyl group, an alkoxy group, a carboxyl group, an ester group, a carbonyl group, an amide group, a hydroxyl group, or a combination thereof, R₈ to R₁₀ each existing independently, or at least two of them being linked to form a substituted or unsubstituted monocyclic or polycyclic aliphatic ring, and
wherein the electrolyte additive is for a rechargeable lithium battery.

2. The electrolyte additive as claimed in claim 1, wherein R₁ is —ROR′OR—, —CH₂OCH₂—, a substituted or unsubstituted phenylene group, or a substituted or unsubstituted biphenylene group, wherein R is a C1 to C4 alkylene group and R′ is a C1 to C4 alkylene group.

3. The electrolyte additive as claimed in claim 1, wherein
Chemical Formula 1 comprises one or more compounds selected from among the compounds represented by Chemical Formula 1A to Chemical Formula 1E:

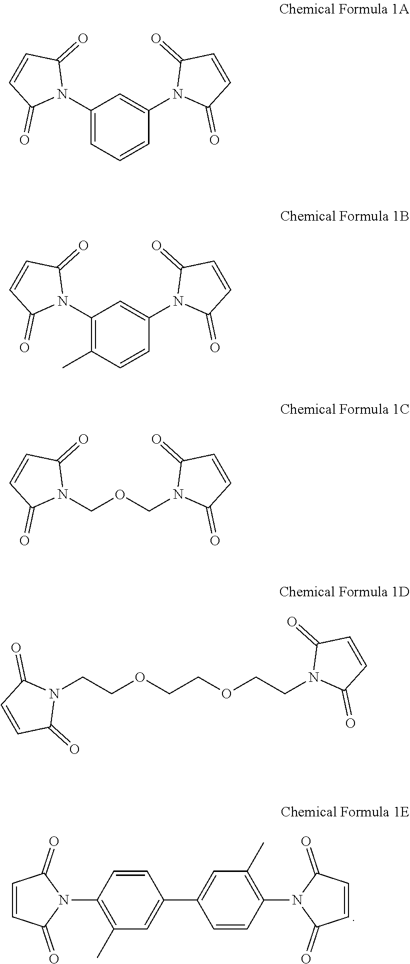 [SMILES: O=C1C=CC(=O)N1c1cccc(N2C(=O)C=CC2=O)c1 ; Cc1ccc(N2C(=O)C=CC2=O)cc1N1C(=O)C=CC1=O ; O=C1C=CC(=O)N1COCN1C(=O)C=CC1=O ; O=C1C=CC(=O)N1CCOCCOCCN1C(=O)C=CC1=O ; Cc1cc(-c2ccc(N3C(=O)C=CC3=O)c(C)c2)ccc1N1C(=O)C=CC1=O]

4. The electrolyte additive as claimed in claim 1, wherein
R₂ is a substituted or unsubstituted C1 to C4 alkylene group, —C(O)—, or —C(CH₃)₂—.

5. The electrolyte additive as claimed in claim 1, wherein Chemical Formula 2 comprises one or more compounds selected from among the compounds represented by Formulas 2A to Chemical Formula 2C: Chemical Formula 2A

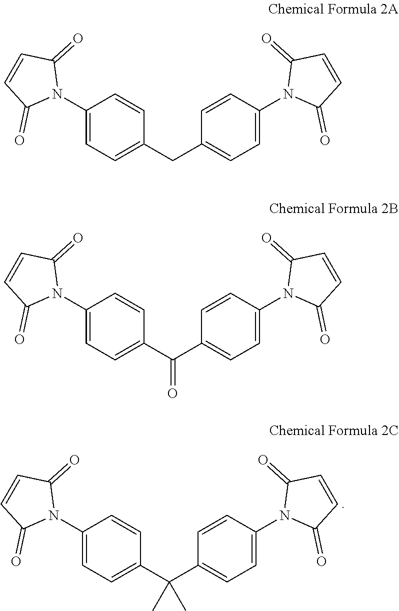 [SMILES: O=C1C=CC(=O)N1c1ccc(Cc2ccc(N3C(=O)C=CC3=O)cc2)cc1 ; O=C(c1ccc(N2C(=O)C=CC2=O)cc1)c1ccc(N2C(=O)C=CC2=O)cc1 ; CC(C)(c1ccc(N2C(=O)C=CC2=O)cc1)c1ccc(N2C(=O)C=CC2=O)cc1]

6. The electrolyte additive as claimed in claim 1, wherein
R₃ to R₇ are each independently hydrogen, a halogen, or a substituted or unsubstituted C1 to C6 alkoxy group.

7. The electrolyte additive as claimed in claim 1, wherein
Chemical Formula 3 comprises one or more compounds selected from among the compounds represented by Formulas 3A to Chemical Formula 3C:

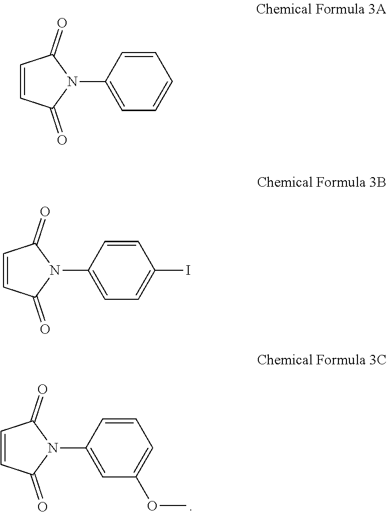

8. The electrolyte additive as claimed in claim 1, wherein
Chemical Formula 4 comprises one or more compounds selected from among the compounds listed in Group 1:

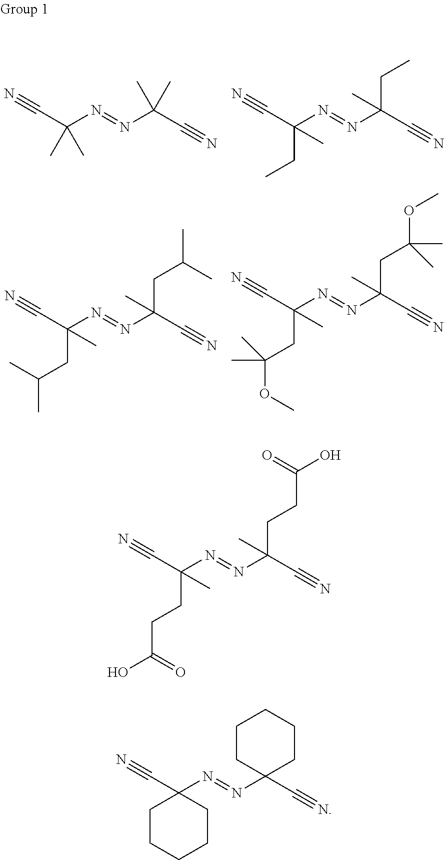

9. The electrolyte additive as claimed in claim 1, wherein
Chemical Formula 4 comprises one or more compounds selected from among the compounds listed in Group 2:

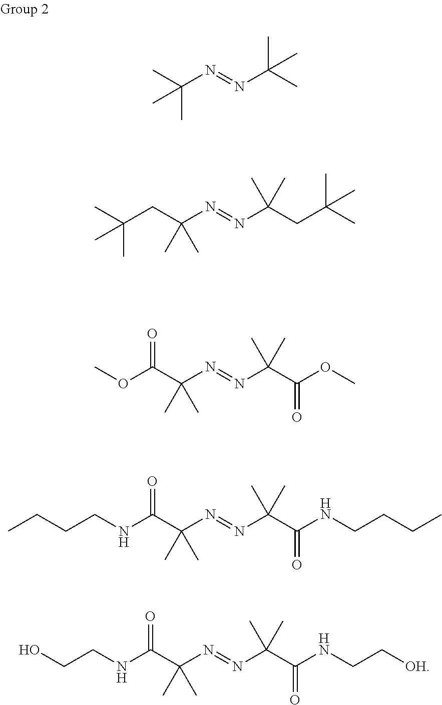

10. The electrolyte additive as claimed in claim 1, wherein
a weight ratio of the first compound and the second compound is about 2:1 to about 10000:1.

11. An electrolyte comprising:
a non-aqueous organic solvent;
a lithium salt; and
an electrolyte additive for a rechargeable lithium battery, the electrolyte additive comprising a polymer obtained by polymerizing a first compound represented by Chemical Formula 1, Chemical Formula 2, or Chemical Formula 3 as a monomer; and a second compound represented by Chemical Formula 4: 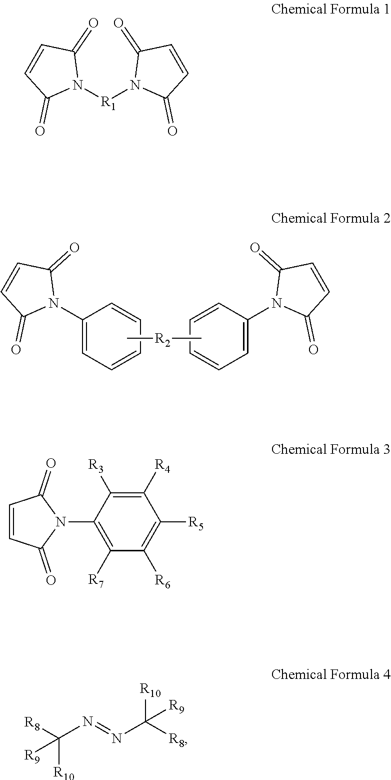
in Chemical Formula 1, R₁ is a substituted or unsubstituted C1 to C4 alkylene group, —C(O)CH₂—, —ROR′OR—, —CH₂OCH₂—, —C(O)—, —O—, —O—O—, —S—, —S—S—, —S(O)—, —CH₂S(O)CH₂—, —(O)S(O)—, —CH₂(C6H₄)CH₂—, —CH₂(C6H₄)O—, a substituted or unsubstituted phenylene group, or a substituted or unsubstituted biphenylene group, R being a C1 to C4 alkylene group and R′ being a C1 to C4 alkylene group,
in Chemical Formula 2, R₂ is a substituted or unsubstituted C1 to C4 alkylene group, —C(O)—, —C(CH₃)₂—, —O—, —O—O—, —S—, —S—S—, —(O)S(O)—, or —S(O)—,
in Chemical Formula 3, R₃ to R₇ are each independently hydrogen, a halogen, a substituted or unsubstituted C1 to C6 alkyl group, a substituted or unsubstituted C1 to C6 alkylene group, a substituted or unsubstituted C1 to C6 aryl group, a substituted or unsubstituted C1 to C6 ether group, or a substituted or unsubstituted C1 to C6 alkoxy group, and
in Chemical Formula 4, R₈ to R₁₀ are each independently hydrogen; a cyano group; a halogen; or a substituted or unsubstituted C1 to C10 hydrocarbon group comprising an alkyl group, a cycloalkyl group, an alkoxy group, a carboxyl group, an ester group, a carbonyl group, an amide group, a hydroxyl group, or a combination thereof, R₈ to R₁₀ each existing independently or at least two of them being linked to form a substituted or unsubstituted monocyclic or polycyclic aliphatic ring, and
wherein the electrolyte is for a rechargeable lithium battery.

12. The electrolyte as claimed in claim 11, wherein
the first compound is included in an amount of about 1 wt % to about 5 wt % based on a total amount of the electrolyte.

13. The electrolyte as claimed in claim 11, wherein
the second compound is included in an amount of about 0.0001 wt % to about 2 wt % based on a total amount of the electrolyte.

14. The electrolyte as claimed in claim 11, wherein
a weight ratio of the first compound and the second compound is about 2:1 to about 10000:1.

15. A rechargeable lithium battery comprising:
a positive electrode comprising a positive electrode active material;
a negative electrode comprising a negative electrode active material;
a separator between the positive electrode and the negative electrode; and
an electrolyte,
wherein the electrolyte comprises a non-aqueous organic solvent, a lithium salt, and an electrolyte additive for a rechargeable lithium battery comprising a polymer obtained by polymerizing a first compound represented by Chemical Formula 1, Chemical Formula 2, or Chemical Formula 3 as a monomer; and a second compound represented by Chemical Formula 4: 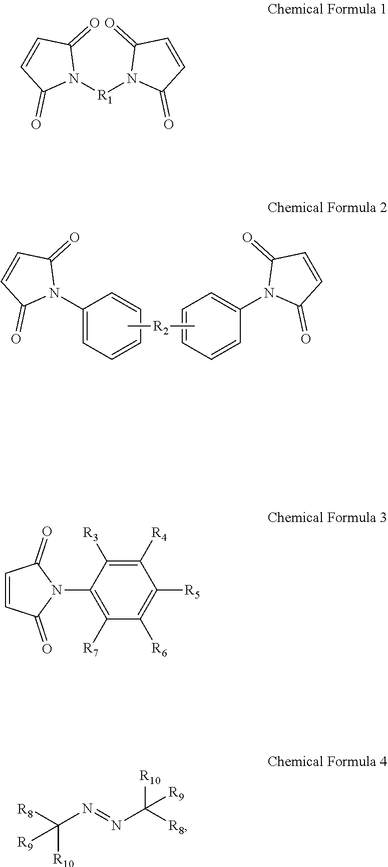
in Chemical Formula 1, R₁ is a substituted or unsubstituted C1 to C4 alkylene group, —C(O)CH₂—, —ROR′OR—, —CH₂OCH₂—, —C(O)—, —O—, —O—O—, —S—, —S—S—, —S(O)—, —CH₂S(O)CH₂—, —(O)S(O)—, —CH₂(C6H₄)CH₂—, —CH₂(C6H₄)O—, a substituted or unsubstituted phenylene group, or a substituted or unsubstituted biphenylene group, wherein R is a C1 to C4 alkylene group and R′ is a C1 to C4 alkylene group,
in Chemical Formula 2, R₂ is a substituted or unsubstituted C1 to C4 alkylene group, —C(O)—, —C(CH₃)₂—, —O—, —O—O—, —S—, —S—S—, —(O)S(O)—, or —S(O)—,
in Chemical Formula 3, R₃ to R₇ are each independently hydrogen, a halogen, a substituted or unsubstituted C1 to C6 alkyl group, a substituted or unsubstituted C1 to C6 alkylene group, a substituted or unsubstituted C1 to C6 aryl group, a substituted or unsubstituted C1 to C6 ether group, or a substituted or unsubstituted C1 to C6 alkoxy group, and
in Chemical Formula 4, R₈ to R₁₀ are each independently hydrogen; a cyano group; a halogen; or a substituted or unsubstituted C1 to C10 hydrocarbon group comprising an alkyl group, a cycloalkyl group, an alkoxy group, a carboxyl group, an ester group, a carbonyl group, an amide group, a hydroxyl group, or a combination thereof, R₈ to R₁₀ each existing independently or at least two of them being linked to form a substituted or unsubstituted monocyclic or polycyclic aliphatic ring.
